(19) United States
(12) Patent Application Publication
(10) Pub. No.: US 2026/0078703 A1
(43) Pub. Date: Mar. 19, 2026

(54) DUAL VARIABLE DISPLACEMENT PUMP FUEL SYSTEM WITH WASHED ACTUATION FLOW AND WASH VELOCITY CONTROL VALVE

(71) Applicant: Hamilton Sundstrand Corporation, Charlotte, NC (US)

(72) Inventors: Ryan Susca, Windsor, CT (US); Ryan Shook, Loves Park, IL (US); August Coretto, Windsor, CT (US); Frank Perrelli, East Haven, CT (US)

(21) Appl. No.: 18/887,805

(22) Filed: Sep. 17, 2024

(51) Int. Cl. F02C 7/232; B01D 29/11; B01D 29/66; B01D 35/02; B01D 35/147; B01D 35/26

(52) U.S. Cl. CPC F02C 7/232; B01D 29/117; B01D 29/668; B01D 35/02; B01D 35/147; B01D 35/26; F05D 2220/323

(57) ABSTRACT

A dual variable displacement pump having an actuation pump sub-system (APS) with an inlet configured to feed fuel from a fuel source into the APS, a first outlet configured for connecting the APS in fluid communication with an actuation system to supply filtered fuel for actuation. The APS has a first pump with a pump inlet in fluid communication with the fuel source, and a pump outlet connected to the third outlet of the APS. The APS further has an actuation filter between the pump outlet of the first VDP with an outlet of the APS. The fuel filter has an input, an output and a washing path. The fuel filter may be cylindrical in shape. The system further comprising a bypass valve having an input from the washing path, and a drain, wherein when the cylindrical fuel filter has a pressure drop from the input to the output, the bypass valve opens to permit cleaning of the filter by allowing fuel to flow from the washing path to the drain. The bypass valve comprises a spool, a valve seat and a spring that has a spring rate (Sk). The output may be provided through an input to the bypass valve, behind the spool.

### CROSS-REFERENCE TO RELATED APPLICATION(S)

This application hereby incorporates by reference U.S. patent application Ser. No. 18/795,819 titled DUAL VARIABLE DISPLACEMENT PUMP FUEL SYSTEM WITH FOC BYPASS AND WASHED ACTUATION FLOW and U.S. patent application Ser. No. 18/828,396 titled FILTER WITH WASH FLOW BYPASS VALVE in their entirety.

### BACKGROUND

The present disclosure relates to fuel systems, and more particularly to fuel systems for aircraft.

In modern aircraft it would be advantageous to eliminate the thermal recirculation system as well as external plumbing, pipe connections, valves, filters, and other components to the extent possible. This may reduce the number of fuel system components, and free space for carrying more fuel. As the number of downstream actuators are added to the system, the fuel provided to these systems should be cleaned. Current prior art systems may not provide sufficient cleaned fuel to meet the needs of the current systems. As the number of actuators increases the filtered fuel need may increase reducing the fuel available to clean the filter. Designers of fuel systems desire to maintain a ratio between washed fuel and washing fuel.

Fluid filters utilized in mechanical systems have existed for some time. There are a number of methods previously utilized to clean the filters when they become clogged. In some applications, variable displacement pumps are used to schedule flow independent of a pressure regulating bypass valve. In these applications supply flow is only generated as needed and results in minimal flow at all other operating conditions. In the case where supply flow needs to be filtered, a barrier screen is the option normally chosen when no bypassed flow is present, and this may result in eventually blockage of the filter. By implementing a passive hydraulic valve that can bypass flow to drain in the event of a clog we can maintain normal filtration operation in the presence of excess contamination.

A traditional system may include a method maintaining wash flow though a continuous bypass. For example, a pressure regulating valve flowing to drain provides continuous flow that may be used for washing. Variable displacement pumps are designed to output flow optimally for all conditions, if we create a bypass path that can be passively opened based on the wash screens delta pressure, we can protect downstream systems without introducing additional flow under normal operation.

### SUMMARY

There is a need in the industry to increase the amount of filtered fuel available in a turbine engine system. The current state of the art systems requires a large percentage of fuel flow to maintain a clean filter. There is a need in the industry for a system that cleans the filter when necessary and seals the washing path when the filter does not require cleaning. Actuation pump sub-systems provide fuel to actuation systems and afterburner control. As systems evolve there is a greater need to provide more filtered fuel to the actuation systems than the earlier designs.

To address these needs, an improved fuel filter wash flow bypass valve is provided which permits cleaning of the fuel filter when the pressure drop across the fuel filter reaches a predetermined value. The fuel filter system has a filter, with an input, an output, and a washing flow. The filter may be a cylinder, wherein in standard operation, fuel enters the inner diameter of the filter and passes through the outer diameter. The system may also operate with the fuel entering the outside of the filter and passing through to the inner diameter. Pressure drops across the filter occur as the filter becomes clogged resulting in a pressure differential between the inlet and the outlet of the filter. As the filter builds up from particulates filtered out of the fuel, the pressure drop across the filter increases as pressure in (Pi) becomes greater than pressure out (Po). This may also result in a drop in the fuel flow across the filter.

The bypass valve has a spool that seals against a valve seat to prevent fuel flow through the bypass valve. When the pressure drop across the filter increases the bypass valve opens to allow fuel to flow across the filter cleaning the debris. The improved system permits a greater fuel flow by maintaining a clean fuel filter.

### BRIEF DESCRIPTION OF THE DRAWINGS

FIG. 1 is a schematic perspective view of an embodiment of a system constructed in accordance with the present disclosure, showing an actuation pump sub-system (APS) supplying a washed fuel flow to an actuation system.

FIGS. 2A & 2B illustrates prior art fuel filters.

FIG. 3 illustrates the improved fuel filter wash flow wash filter control valve in the closed position.

FIG. 4 illustrates the improved fuel filter wash flow wash filter control valve in the open position.

FIG. 5 illustrates a second improved fuel filter wash flow wash filter control valve in the closed position.

FIG. 6 illustrates the second improved fuel filter wash flow bypass valve in the open position.

### DETAILED DESCRIPTION

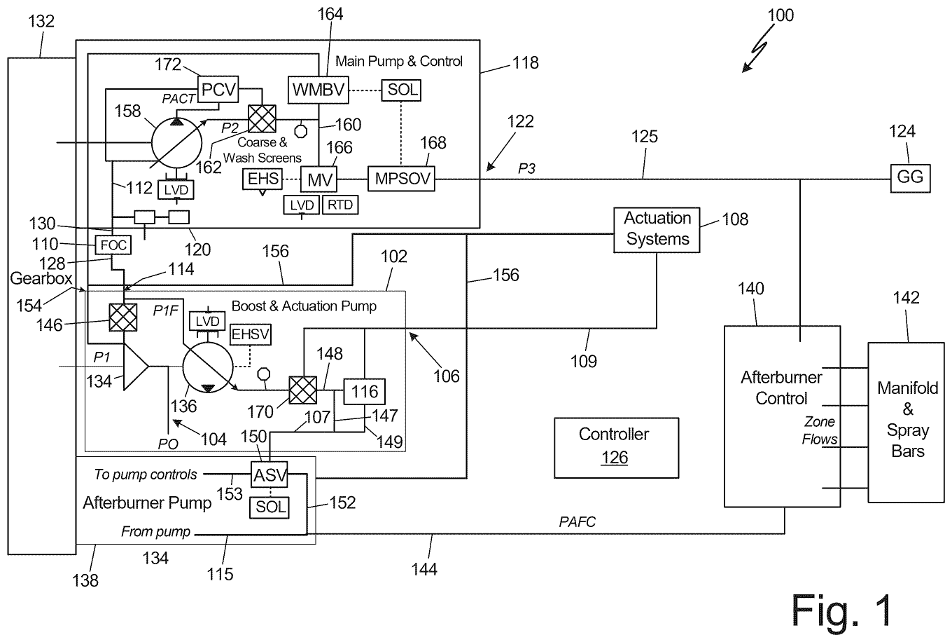

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. The systems and methods described herein can be used to provide a washed fuel flow to an actuation system, eliminating the need for a barrier filter and associated piping, pipe connections, valves, and sensors.

The system 100 includes an actuation pump sub-system (APS) 102 with an inlet 104 configured to feed fuel from a fuel source, e.g. at pressure P0, into the APS 102, a first outlet 106 configured for connecting the APS 102 in fluid communication with an actuation system 108 to supply filtered fuel flow for actuation such as for end effectors aboard an aircraft through a line 109. A fuel oil cooler (FOC) 110 is in a supply line 112 that is in fluid communication with the second APS outlet 114 of the APS 102. A main pump and control sub-system (MPCS) 118 has a main inlet 120 connected in fluid communication with the supply line 112 downstream of the FOC 110. The MPCS 118 includes a main outlet 122 for supplying fuel to a downstream gas generator (GG) 124 through a line 125, e.g. at elevated pressure P3. The gas generator (GG) can include fuel injectors in a combustor of a gas turbine engine.

A gearbox 132 may be connected to drive one or more fuel pumps 134, 136 in the APS 102, and to drive one or more pumps 158 of the MPCS 118. An afterburner pump 138 is also operatively connected to be driven by the gearbox 132. The afterburner pump 138 may be connected in fluid communication to receive flow from the supply line 112 via line 115 and to supply an afterburner control 140, which controls flow of fuel to the manifold and spray bars 142 of an afterburner system of the gas turbine engine of the aircraft. The line 144 that connects the afterburner pump 138 in fluid communication with the afterburner control 140 can be pressurized to the elevated pressure, PAFC, by afterburner pump 138.

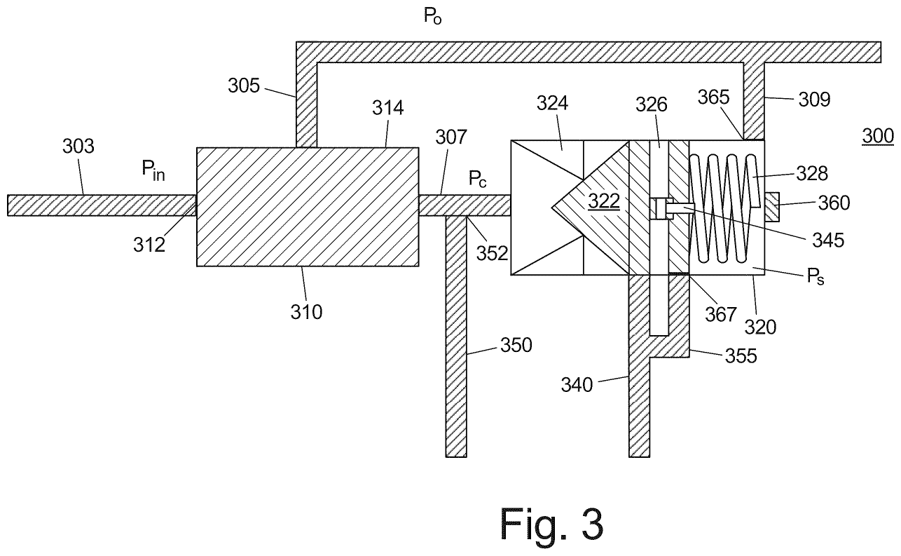

The APS 102 includes a boost pump 134 operatively connected between the inlet 104 of the APS 102 and the second APS outlet 114 for boosting pressure of fuel from the supply at P0 to the pressure in the supply line 112, P1. A main filter 146 may be a barrier filter included in the line connecting the boost pump 134 to the second APS outlet 114. The APS 102 includes a first variable displacement pump (VDP) 136 with a pump inlet in fluid communication to be supplied with filtered, boosted pressure PIF from the boost pump 134, downstream of the main filter 146, and a pump outlet connected in fluid communication by a line 148 with the third outlet 107 of the APS 102 providing flow pressurized at PHW. An actuation filter 170 included in line 148 upstream of the third outlet 107. Actuation filter 170 is a wash filter whereby particles and debris collected on a filter element, a screen, or the like is cleaned by a washing flow through line 148. A washed flow provided downstream of the filter element flows through first outlet 106 of APS 102 and along line 109 to actuation systems 108. A wash filter control valve 116 is provided at the output of actuation filter 170. The wash filter control valve 116 allows for flow from the actuation filter 170 for cleaning and the discharge from the wash filter control valve 116 is provided through line 149 to third outlet 107. An additional line 147 may be provided to provide for a continuous cleaning of filter 170. Note that a greater flow will be provided through third outlet 107 when wash filter control valve 116 is open. By limiting the cleaning flow, a greater percentage of fuel may be provided to actuation system 108. However, when cleaning of actuation filter 170 is desired, wash control valve 116 will open permitting a greater cleaning flow through line 148. Operation of the wash filter control valve 116 will be discussed further in FIGS. 3-6.

An actuation selector valve (ASV) 150 may be fluidly connected to line 148 at third outlet 107 of APS 102, and fluidly connects with pump outlet 160 of MPCS 118 via line 153. The ASV 150 may be further connected in fluid communication with a line 152 connecting to the line 144 of the afterburner pump 138 for backup supply to the afterburner control 140 from the APS 102. The APS 102 includes a port 154 connected in fluid communication with the outlet of the boost pump 134, wherein the port 154 may be connected in fluid communication with the actuation systems 108, with the afterburner pump 138, and with a port of the MPCS 118 via a branching line 156 that returns flow from the windmill bypass valve (WMBV) 164, from the actuation system 108, and from the afterburner pump 138, to the boost outlet.

The MPCS 118 includes a second VDP 158 with a pump inlet in fluid communication with the main inlet 120 of the MPCS 118, and a pump outlet line 160 in fluid communication with the main outlet 122 of the MPCS 118. A coarse and wash screens component 162 may be included in the pump outlet line 160 upstream of the WMBV 164 and MV 166. A windmill bypass valve (WMBV) 164 may be in fluid communication with a branch of the pump outlet line 160 and with the port 154 of the APS 102 for returning bypass flow to the APS 102 from the second VDP 158. A metering valve (MV) 166 in pump outlet line 160 may be configured for metering flow to the gas generator 124. A main pump shut off valve (MPSOV) 168 in the pump outlet line 160 downstream of the MV 166 may be configured to stop flow out of the MPCS 118 for shutoff.

The controller 126 may be operatively connected to control the first and second VDPs 136, 158, the MPSOV 168, the WMBV 164, the MV 166, the pressure control valve (PCV) 172, and the ASV 150, e.g. by electrically controlling the electrohydraulic servo valves (EHSVs) and solenoids (SOLs) indicated in FIG. 1. The PCV 172 controls the variable displacement mechanism of the second VDP 158, whereas the first VDP 136 can have its variable displacement mechanism controlled directly by an EHSV. The controller 126 may be operatively connected to sensors, including the linear variable differential transformers LVDTs, resistance thermometer RTD, and pressure sensors P, in the MPCS 118, the first and second VDPs 136, 158, the MPSOV 168, the WMBV 164, the MV 166, the PCV 172, and the ASV 150. The controller can include machine readable instructions in the form of analog circuits, solid state digital logic, or a processor can read the instructions to carry out the methods disclosed herein.

During steady state operation of system actuation systems 108, pressure within actuation systems 108 is not varying. In this state (i.e., a first state), ASV 150 fluidly connects the outlet of first VDP 136 to afterburner control 140 via line 148, line 153, line 115 and line 144, each line pressurized to PHW, while flow into line 152 and to MPCV 118 is blocked. Periodically, flow within line 109 may increase, supplying additional flow to actuation systems 108. While flow within line 109 increases relative to steady state operation, particles and debris momentarily collect on actuation filter 170. Once steady state operation of actuation systems 108 resumes, actuation systems 108 requires less pressure and/or flow from first VDP 136 and flow into line 109 returns to a nominal amount, allowing washing flow through 148 to remove particles and other debris from actuation filter 170. The duration of transient operation is brief relative to afterburner operation (e.g., one to three seconds) such that the accumulation of particles and debris during this period does not block flow through actuation filter 170.

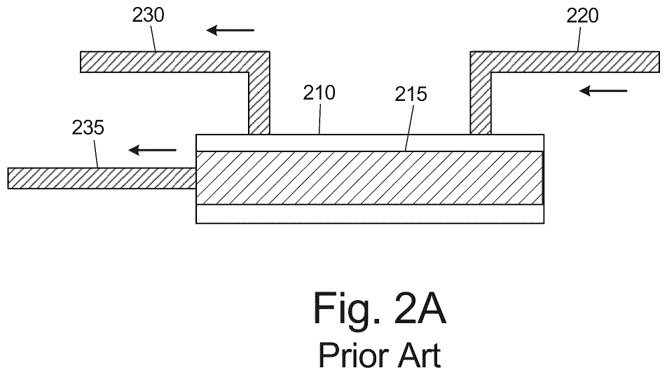

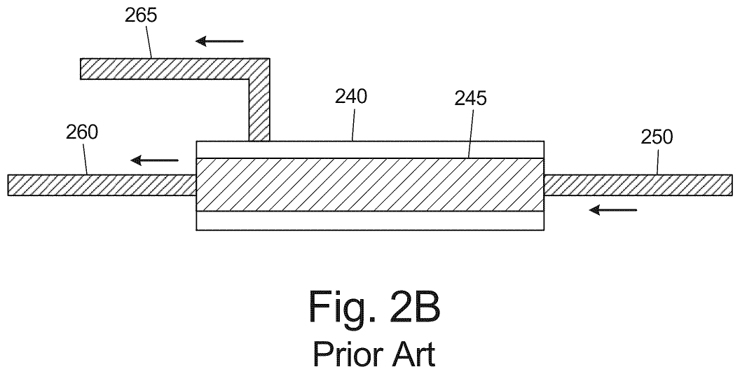

FIGS. 2A & 2B illustrate a prior art filter utilized to provide filtered fuel to a system. The prior art filters are no longer viable as the filters require a large percentage of the fuel flowing into the filter for cleaning. As a result, the percentage of filtered fuel provided may not meet the needs of the system. FIG. 2A illustrates a filter 210 with an input 220 and an output 230. A second output 235 is also provided. Filter 210 has a filter element 215 which allows for fuel to pass through filter element 215 and out second output 235. Fuel is provided through input 220 to the filter 210 with the majority of fuel passing out output 230. As can be seen by maintaining the flow across filter element 215, the filter will remain clean. However, the washing flow required from inlet 220 to outlet 230 may be detrimental to the efficiency of the system if clean fluid 235 at second output 235 is the primary goal, and the washing flow required may be higher than the amount of clean fluid produced.

FIG. 2B illustrates an additional prior art filter configuration. Where the fuel in FIG. 2A was introduced on the outside of the filter element 215, in FIG. 2B the fuel is introduced into the inner circumference of the filter element 245. Filter 240 incorporates a filter element 245 similar to the filter element 215 of FIG. 2A. The filter element may be a tubular metal mesh filter which allows fuel to pass while preventing the flow of debris. An input 250 to filter 240 may provide fuel into the inner diameter of filter element 245. A first output 260 outputs through the inner diameter of the filter element 245. Cleaned fuel will pass through filter element 245 and out output 265. Again, as illustrated above, the washing flow required from inlet 250 to outlet 260 may be detrimental to the efficiency of the system and may be higher than the amount of clean fluid produced. While this may be acceptable for current systems, newer designs require that a larger portion of the fuel be cleaned to provide clean fuel to sensitive systems. As a result, new design is required to allow for a larger portion of the fuel to be cleaned.

FIG. 3 illustrates an improved fuel filter wash flow check valve in the closed position. The fuel filter system 300, has a filter 310, with a filter input 303, a filter output 305, and a washing flow path 307. The filter 310 may be a cylinder, wherein in standard operation, fuel enters the inner diameter 312 of the filter and passes through the outer diameter 314. As filter 310 becomes clogged, pressure across filter 310 drops resulting in a delta between the pressure at the input Pi and the pressure at the outlet 305 Po. This may be the result of the pressure Pi increasing or Po decreasing or a combination thereof. As filter 310 builds up particulates filtered out of the fuel, the pressure drop across the filter increases as Pi becomes greater than Po. This may also result in a drop in the fuel flow across the filter.

The fuel filter wash flow bypass valve of FIG. 3 further includes a bypass valve 320. Bypass valve 320 comprising a spool 322, that seals against valve seat 324 to prevent fuel flow through the bypass valve 320. Bypass valve 320 is connected to filter 310 through washing flow line 307. Washing flow line 307 is down stream from input 312 and is on the inner diameter 312 of filter 310. The washing flow line 307 is a washing path for filter 310. When fuel flows in filter 310 across the inner diameter 312 and out washing flow line 307 the inner surface of the filter 310 may be cleaned. The greater the fluid flow across the inner surface of filter 310, the greater the cleaning affect on filter 310. While filter 310 in this example is a cylindrical filter with the fuel entering the interior of the cylinder, the filter 310 may be of any filter design that provides an output of filtered liquid while also providing for a washing path to allow for the cleaning of the filter surface.

Valve 320 may be assembled from materials that will support high pressure valves with metal-to-metal seals. One example of an acceptable material is 440 series stainless steel. In another embodiment the seal between spool 322 and valve seat 324 may include an actual face seal element composed of GLT-Viton or PTFE depending on flow rate and pressure drop. Alternatively, the seal may comprise a face seal. A face seal may comprise a gasket between the spool and the valve seat. For a face seal the spool will seal against a flat portion of the valve seal and may incorporate a ring.

The output line 305 provides fuel through input 309 to check valve 320 behind spool 322. Input 309 may include an orifice 365 to tune the pressure spool pressure (Ps) located behind spool 322. As a result, the pressure behind the spool 322 (Ps) may be less than or greater than Po. The pressure resulting behind spool 322 is dependent upon the configuration of bypass valve 320. Spool 322 seals in part due to pressure applied by spring 328 force Sk and pressure Ps. As the washing flow path 307 is provided to the input to bypass valve 320, the pressure across the spool equates to Pc*Afront versus Ps*Aback+Sk. As can be seen, when Pc*Afront is greater than Ps*Aback+Sk, then spool 322 opens, allowing fuel to flow across filter 310 cleaning the inner diameter of the filter. When Pc*Afront is less than Ps*Aback+Sk, then spool 322 closes and seals against valve seat 324. The pressure applied by spring 328 to spool 322 is calculated as the spring rate Sk. For discussion purposes, Pc closely follows Pin pressure. Afront is the area of the front of the spool 322 under pressure and Aback is the area of the back of spool 322 receiving pressure Ps. The spring tension Sk is defined as follows:

$$Sk = ( load - initial tension ) / travel$$

Pressures for systems input 312 (Pin) for this system are generally on the high pressure side of the system (i.e. Pin may be coming directly from a pump). The pressure coming into the filter 310 may be anywhere from 1000 psig-3000 psig based on legacy systems. However, depending on application the pressure could go higher or lower. The drain 340 is generally on low side of pump possibly between 100-300 psig. When cleaning flow velocity through filter is adequate debris will be carried off of filter and downstream”.

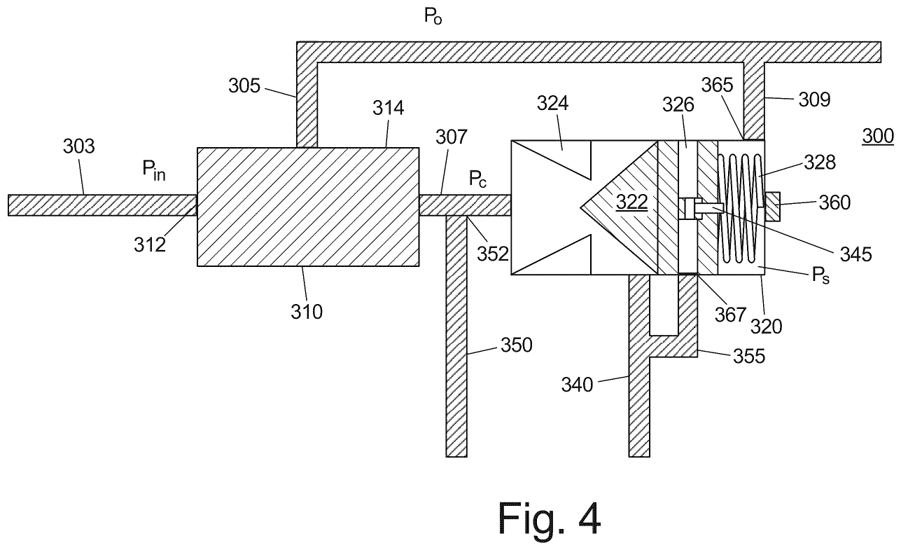

FIG. 4 illustrates spool 322 in an open position. When open, fluid from the washing flow path 307 can pass through bypass valve 320 to drain 340, thus cleaning filter 310. Drain 340 ejects the fluid that passes through it to the third outlet 107 of FIG. 1. As seen spool 322, further comprises channel 326 and pass through 345. Pass through 345 may allow output fluid from input 309 to pass through spool 322, to channel 326 and exit though drain 355. When in the closed position as seen in FIG. 3, drain 355 may be sealed by spool 322. Drain 355 will join drain 340 and be discharged into third outlet 107 of FIG. 1.

Drain 355 may also include a second orifice 367 to restrict the flow of fluid into drain 355. A second embodiment would be to size of input 309 through orifice 365 and drain 355 with orifice 367 to ensure pressure behind spool 322 (Ps) drops to keep the spool 322 open. By implementing drain 355 on the back side of the spool 322, the system allows for pressure on the back side of spool 322 (Ps) to drop and maintain Pc>Ps+Sk once the valve opens. When channel 326 is open to drain 355, the delta between Pc and the pressure Ps behind spool 322 may increase to maintain spool 322 in an open position. The spool 322 will thereby be latched open. Line 309 of FIGS. 3 & 4 may be sized or an orifice 365 may be sized to control the flow of fluid to the back side of spool 322. The drain 355 on the back side of spool 322 is not necessary, however it adds a hysteresis effect which can be tuned. With certain sizing of line 309 and 355, or the inclusion of orifices 365 and 367, it may be possible to cause the bypass valve 320 to stay fully open for the duration of a flight. With other sizing the bypass valve 320 would add additional hysteresis. It is possible to make the bypass flow through washing flow path 307 more predictable by latching the check valve 320 open. Once the check valve 320 is open, it will have the same bypass effective area at all times. If check valve 320 is opening and closing, the bypass effective area will be changing.

In another embodiment, the drain 355 of FIGS. 3 & 4 may be omitted. With the removal of the drain 355, the pressure will be regulated through orifice 365. This may result in the pressure Ps plus Sk being greater than Pc. In this embodiment, it may be possible that the valve may close when the wash flow is no longer necessary.

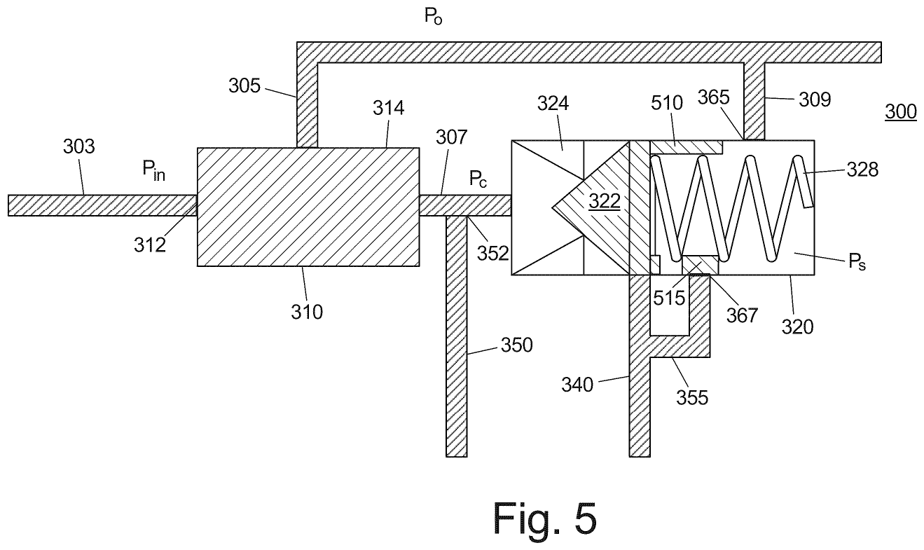

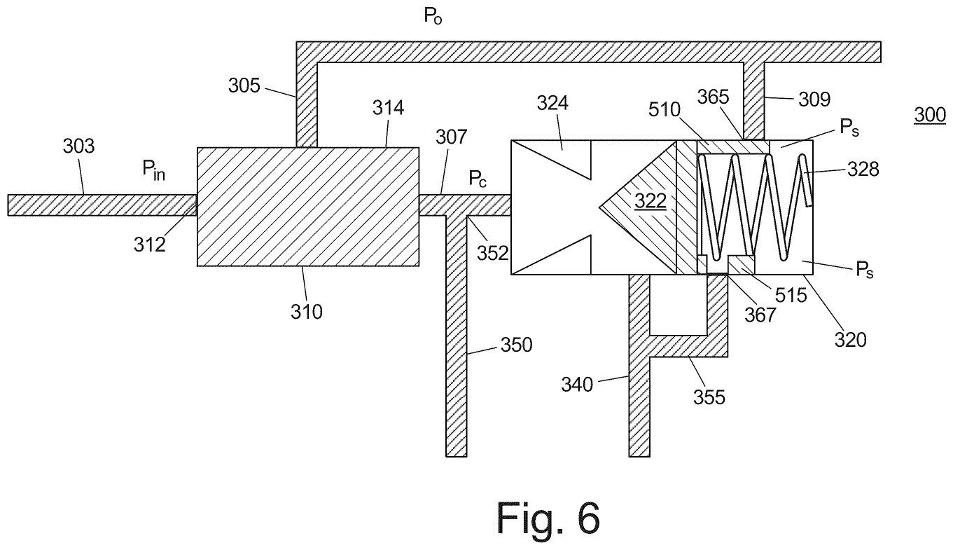

In yet another embodiment as shown in FIGS. 5 & 6 would be to block the input 309 to the backside of spool 322 when spool 322 opens. As illustrated in FIG. 5 and FIG. 6, the channel 326 shown in FIG. 3 and FIG. 4 is eliminated. Spool 322 incorporates a sleeve 510 on the backside of spool 322. Sleeve 510 is designed such that input 309 is open to the backside of spool 322 when the spool 322 is in a closed position. In addition, an output drain 355 may be closed by sleeve 515, when the spool 322 is in a closed position. The sleeve 510 and 515 may be formed as a cylinder on spool 322 or they may be separate elements attached to spool 322.

As shown in FIG. 6, when spool 322 is in an open position, sleeve 510 closes input 309 while sleeve 515 opens to output drain 355. By implementing this embodiment, the system allows for pressure on the back side of spool 322 (Ps) to drop and Pc>Ps+Sk to remain constant once the valve opens. In this embodiment Ps, behind spool 322 may be lower than Po. The backside of spool 322 is open to drain 355, the delta between Pc and the pressure Ps behind spool 322 may be increased to maintain spool 322 in an open position.

The bypass valve may operate in a number of manners. As the pressure drop across filter 310 increases, the spool 322 may open gradually as the ratio of Pc to Po increases, or alternatively, the spool 322 may open completely when Po*Afront>Pc*Aback+Sk. Spring 328 may be adjustable to tune bypass valve 320. To tune spring 328, a tuning screw 360 or other device may be included to tune spring 328. Drain 355 allows for the output flow from input 309 to drain 355, thus lowering P0 at spool 322. As seen in FIGS. 3 & 4, by lowering Po, the spool 322 will remain open longer, in affect creating a hysteresis for spool 322. By tuning the location of channel 326 a “latch open” effect can be enabled, and the size of channel 326 in relation to line 309 can tune the amount of hysteresis effect the valve exhibits. This feature allows additional tuning options but is not necessary for the operation of the valve and in different embodiments this feature may be removed.

By allowing for variable flow through bypass valve 320, it may be possible to limit the impact of the washing process. Thus, when the filter 310 is blocked, a full flow of the fluid cleans the filter 310 quickly. When the filter 310 does not have as significant a blockage, the bypass valve 320 may not need to open as far, thus reducing flow through washing 307 or the bypass valve 320 may not open for as long a period of time.

In another embodiment, a second drain 350 may be provided to washing flow 307. The second drain 350 provides the fluid to additional line 147 of FIG. 1 The second drain 350 may be set to allow for constant flow across filter 310. Second drain 350 may incorporate an orifice 352 to limit the flow of fuel through second drain 350.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
an actuation pump sub-system (APS) with an APS inlet configured to feed fuel from a fuel source into the APS, a first outlet configured for connecting the APS in fluid communication with an actuation system to supply fuel flow for actuation, a second APS outlet, and a third APS outlet, wherein the APS comprises:
a first pump with a pump inlet in fluid communication with the fuel source, and a pump outlet connected in fluid communication with the third outlet of the APS; and
an actuation filter in a line connecting the pump outlet of the first pump with the third outlet of the APS, wherein the actuation filter comprises:
a fuel filter having a filter input, a filter output and a washing path; a bypass valve having a first input from the washing path, and second input from the output, and a first drain, wherein when the fuel filter has a pressure drop from the input to the output, the bypass valve opens to permit cleaning of the filter by allowing fuel to flow from the washing path to the first drain; and
an afterburner pump connected in fluid communication with the first drain.

2. The system of claim 1 wherein the bypass valve further comprises a spool, a valve seat and a spring that has a spring rate (Sk).

3. The system of claim 2, wherein the filter output is provided to the second input behind the spool.

4. The system of claim 3, wherein the bypass valve is configured to have a pressure at the first input (P_{c}*Afront), a pressure behind the spool (Po*Aback)), and the spring exhibits a force (Sk), wherein the bypass valve opens with P_{c}*Afront>Pₒ*Aback+Sk.

5. The system of claim 4, wherein the bypass valve has an orifice at the second input configured to tune the pressure behind the spool.

6. The system of claim 5, wherein the bypass valve is tuned to open when (Pc*Afront) is greater than ((Po*Aback)+Sk) and close when (Pc*Afront) is less than ((Po*Aback)+Sk).

7. The system of claim 4, wherein the bypass valve has a second drain behind the spool.

8. The system of claim 7, further comprising a third drain on the washing path.

9. The system of claim 4, wherein the output is configured to be provided to an actuation system.

10. The system of claim 8, wherein the bypass valve has a second orifice in the second drain.

11. The system of claim 4, wherein the spool is configured to seal the second input when in an open position.

12. A system comprising:
an actuation pump sub-system (APS) with an APS inlet configured to feed fuel from a fuel source into the APS, a first APS outlet configured for connecting the APS in fluid communication with an actuation system to supply fuel flow for actuation, an APS second APS outlet, and a third APS outlet, wherein the APS comprises:
a first pump with a pump inlet in fluid communication with the fuel source, and a pump outlet connected in fluid communication with the third outlet of the APS; and
an actuation filter in a line connecting the pump outlet of the first pump with the APS third outlet, wherein the actuation filter comprises: a fuel filter having a filter input, a filter output and a washing path; a bypass valve having a first input from the washing path, and second input from the filter output, and a first drain, wherein when in operations when the fuel filter has a pressure drop from the filter input to the filter output, the bypass valve opens to permit cleaning of the filter by allowing fuel to flow from the washing path to the first drain;
a second drain from the washing path; and
an afterburner pump connected in fluid communication with the first drain; and
an actuation system connected in fluid communication to the filter output.

13. The system of claim 12 wherein the bypass valve comprises a spool, a valve seat and a spring that has a spring rate (Sₖ).

14. The system of claim 13, wherein the spool seals the second input to the bypass valve when the spool is in an open position.

15. The system of claim 12, wherein when the spool opens, the spool remains open until fuel flow through the filter input is reduced when in operation.

16. The system of claim 14 wherein when Pc*Afront<Po*Aback+Sk, the bypass valve is closed when in operation.

17. The system of claim 13 wherein the spring rate (Sk) is tunable.

18. The system of claim 13 further comprising a seal, wherein the spool seals against the spool when the bypass valve is closed.

19. The system of claim 17, wherein the spring rate (Sk) is set to limit the opening of the spool.

20. The system of claim 14 wherein the spring rate (Sk) is tunable.
